(19) United States
(12) Patent Application Publication
(10) Pub. No.: US 2013/0271460 A1
(43) Pub. Date: Oct. 17, 2013

(54) APPARATUS AND METHOD FOR GENERATING 3D TREE IMAGES

(71) Applicant: ELECTRONICS AND TELECOMMUNICATION RESEARCH INSTITUTE, Daejeon-city (KR)

(72) Inventor: Jae-Hwan KIM, Daejeon-city (KR)

(73) Assignee: ELETRONICS AND TELECOMMUNICATIONS RESEARCH INSTITU, Daejeon-city (KR)

(21) Appl. No.: 13/712,874

(22) Filed: Dec. 12, 2012

(30) Foreign Application Priority Data
Apr. 13, 2012 (KR) 10-2012-0038391

(51) Int. Cl. G06T 17/10

(52) U.S. Cl. CPC G06T 17/10
USPC 345/420

(57) ABSTRACT

Disclosed is an apparatus for generating 3D tree images, which comprises an object separation unit which is configured to extract a background and objects from an externally received 2D tree image and to separate a separation target object from the objects; a pattern matching unit which is configured to extract skeleton pattern information from the separation target object and to generate a pattern matching information by matching the skeleton pattern information with the tree shape pattern information which is previously stored in an object pattern database (DB); and a 3D simulation unit modeling simulation unit which is configured to generate a 3D virtual tree model with the aid of the pattern matching information and to express the generated virtual tree model by way of a self-growth simulation.

### CROSS-REFERENCE(S) TO RELATED APPLICATIONS

This application claims priority to Korean Patent Application No. 10-2012-0038391, filed on Apr. 13, 2012, which is incorporated herein by reference in its entirety.

### BACKGROUND OF THE INVENTION

1. Field of the Invention

The present invention relates to an apparatus and a method for generating 3D tree images, and particularly to an apparatus and a method for generating 3D tree images which make it possible to effectively generate a digital tree image (a 3D virtual tree image generated from a CG (Computer Graphic) which is generally used when producing contents such as a movie, a game, an advertisement, etc.

2. Description of Related Art

A natural object such as a tree is an important element for an actual expression when producing contents such as a movie, a game, etc., and it is hard to express a living and growing natural object in detail with the aid of 3D expression software, which is widely used.

A conventional natural object 3D expression method is generally classified into the following four methods: a procedural method which makes it possible to generate and grow a specific type of tree in various forms with the aid of a parameter adjusting method, a rule-based method of generating trees with the aid of a transition procedure method covering from a simple initial state to a complicated state, an image-based method which is directed to recovering a static structure of a tree with the aid of actual tree images, and a sketch-based method of generating a tree model from branch skeletons which are drawn by a user. The advantages and disadvantages of each method will be described.

First of all, the rule-based method is characterized in that various kinds of plant images can be intuitively generated using a previously defined grammar rule whereas each parameter control cannot be easily handled by a user, so only a skilled user can generate a desired shape of a plant. The procedural method is developed in an attempt to improve the disadvantages of the rule-based method and has limited kinds of tree models to be imaged; however it is intuitive and easy to control an object parameter while ensuring various kinds of plant tree images. The image-based method makes it possible to express a tree model in details like an actual tree; however there are still technical limits in an accurate segmentation procedure for the sake of duplicated branches and leaves in terms of a structure recovery and a difficult problem for a model control by way of a parameter control. The sketch-based method has a limit in that user's hard work and good skill are needed when drawing complicated branch skeletons as disclosed in the article entitled “Interactive Design of Botanical Trees using Freehand Sketches and Example-based Editing” in 2005 Computer Graphic Forum by Makoto Okabe, Shigeru Owada, Takeo Igarashi.

### SUMMARY OF THE INVENTION

Accordingly, the present invention is directed to resolving the above mentioned problems, and it is an object of the present invention to provide an apparatus and a method for generating 3D tree images in which the changes of virtual tree models can be intuitively and easily recognized and understood when generating a 3D virtual tree model based on the procedural method in a case in which a dynamic 3D imaginary tree image, the shape of which can be controllable, is generated from a still 2D tree image.

It is another object of the present invention to provide an apparatus and a method for generating 3D tree images which make it possible to enhance biological understandings in such a way to perform a self-growth simulation of a 3D virtual tree with the aid of a self-growth program.

To achieve the above objects, there is provided an apparatus for generating 3D (3-Dimensional) tree images according to an embodiment of the present invention which comprises an object separation unit which is configured to extract a background and an object from an externally received 2D (2-Dimensional) tree image and to separate a separation target object from the object; a pattern matching unit which is configured to extract skeleton pattern information from the separation target object and to generate pattern matching information by matching the skeleton pattern information with the tree shape pattern information which is previously stored in an object pattern database (DB); and a 3D simulation unit modeling simulation unit, which is configured to generate a 3D virtual tree model with the aid of the pattern matching information and to express the generated virtual tree model by way of a self-growth simulation.

In addition, the object separation unit comprises an extraction unit which is configured to extract a background and an object from the 2D tree image; an object setting unit which is configured to store the information of the previously set separation target object; a first object separation unit which is configured to separate and store a branch object which is one of the separation target objects; and a second object separation unit which is configured to separate and store a leaf object which is one of the separation target objects.

In this case, the extraction unit is configured to extract the background and the object with the aid of an image matting technique.

In addition, the pattern matching unit comprises a skeletonization unit which is configured to generate skeleton pattern information in such a way to skeletonize a branch object among the separation target objects; a graph formation unit which is configured to express the skeleton pattern information of the branch object in the form of a graph formed of edges and nodes; a parameter value extraction unit which is configured to extract a parameter value with respect to the branch object from the graph; and a matching information generation unit which is configured to generate a pattern matching information in such a way to match a tree shape defined from the parameter value with the tree shape pattern information.

In this case, the parameter value is one among an angle or rotation angle value between the branches and a size ratio value between a parent branch and a child branch.

In addition, the 3D simulation unit modeling simulation unit comprises a modeling unit which is configured to model a virtual tree model with the aid of the pattern matching information; and a simulation unit which is configured to simulate a self-growth of the virtual tree model by way of a self-growth program.

Meanwhile, there is further provided a user interface which is configured to generate a 3D virtual tree image in such a way to receive from a user an editing command with respect to a self-growth simulation of the virtual tree model.

To achieve the above objects, there is provided a method for generating 3D (3-Dimensional) tree images according to an embodiment of the present invention which comprises externally receiving a 2D (2-Dimensinal) tree image; separating a separation target object from an object in such a way to extract a background and an object from a 2D (2-Dimensional) tree image with the aid of an object separation unit; generating a pattern matching information in such a way to match, with the aid of the pattern matching unit, skeleton pattern information extracted from the separation target object with the tree shape pattern information which is previously stored in an object pattern database; generating a 3D virtual tree model with the aid of the pattern matching information by means of a 3D simulation unit modeling simulation unit; and expressing the generated virtual tree model based on a self-growth simulation by means of the 3D simulation unit modeling simulation unit.

In addition, the step of separating a separation target object from the object in such a way to extract a background and an object from the 2D tree images is characterized in that a background and a tree are extracted from the 2D tree images with the aid of an image matting technique and a branch object and a leaf object, which are separation target objects, are separated from the objects.

In addition, the step of generating pattern matching information in such a way to match the skeleton pattern information extracted from the separation target object with the tree shape pattern information, which is previously stored in an object pattern database, is characterized in that the skeleton pattern information is generated in such a way to skeletonize a branch object among the separation target objects.

In addition, the step of generating pattern matching information in such a way to match the skeleton pattern information extracted from the separation target object with the tree shape pattern information, which is previously stored in an object pattern database, is characterized in that the pattern matching information is generated in such a way to match a tree shape defined from a parameter value extracted from the skeleton pattern information with the tree shape pattern information.

In addition, the step of expressing the generated virtual tree model based on a self-growth simulation is characterized in that a self-growth with respect to the virtual tree model is simulated by way of a self-growth program.

In addition, the step of expressing the generated virtual tree model based on a self-growth simulation is characterized in that a 3D virtual tree image is generated in such a way to receive from a user an editing command with respect to a self-growth simulation of the virtual tree model.

### ADVANTAGEOUS EFFECTS

According to an apparatus and a method for generating 3D tree images of the present invention, the changes of a virtual tree model can be intuitively and easily understood in such way to generate a 3D virtual tree model based on a procedural method when generating a dynamic 3D virtual tree image, the shape of which can be controlled, from a still 2D tree image.

In addition, it is possible to enhance a biological understanding in such a way to perform a self-growth simulation on a 3D virtual tree with the aid of a self-growth program.

### BRIEF DESCRIPTION OF THE DRAWINGS

FIG. 1 is a view illustrating a construction of an apparatus for generating 3D tree images according to an embodiment of the present invention.

FIG. 2 is a view illustrating a detailed construction of an object separation unit which is adapted to an apparatus for generating 3D tree images according to an embodiment of the present invention.

FIG. 3 is a view illustrating a detailed construction of a pattern matching unit which is adapted to an apparatus for generating 3D tree images according to an embodiment of the present invention.

FIG. 4 is a view illustrating a detailed construction of a 3D modeling simulation which is adapted to an apparatus for generating 3D tree images according to an embodiment of the present invention.

FIG. 5 is a view illustrating a flow chart of a method for generating 3D tree images according to an embodiment of the present invention.

FIG. 6 is a view illustrating an example of a step S200 of a method for generating 3D tree images according to an embodiment of the present invention.

FIG. 7 is a view illustrating work content of a project file which corresponds to a step S200 of a method for generating 3D tree images according to an embodiment of the present invention.

FIG. 8 is a view illustrating the examples of steps S300 and S400 of a method for generating 3D tree images according to an embodiment of the present invention.

FIG. 9 is a view illustrating a work content of a project file which corresponds to a step S300 of a method for generating 3D tree images according to an embodiment of the present invention.

FIG. 10 is a view illustrating a work content of a project file which corresponds to a step S400 of a method for generating 3D tree images according to an embodiment of the present invention.

### DESCRIPTION OF SPECIFIC EMBODIMENTS

The most preferred embodiments of the present invention will be described with reference to the accompanying drawings in order for an ordinary person to easily implement the technical concepts of the present invention. It is noted that the same elements will be given the same reference numerals when adding the reference numerals to the elements shown on each drawing. In addition, the descriptions on the related constructions or functions which could seem to make unclear the subject matters of the invention will be omitted from the descriptions of the invention.

The apparatus and method for generating 3D tree images according to an embodiment of the present invention will be described.

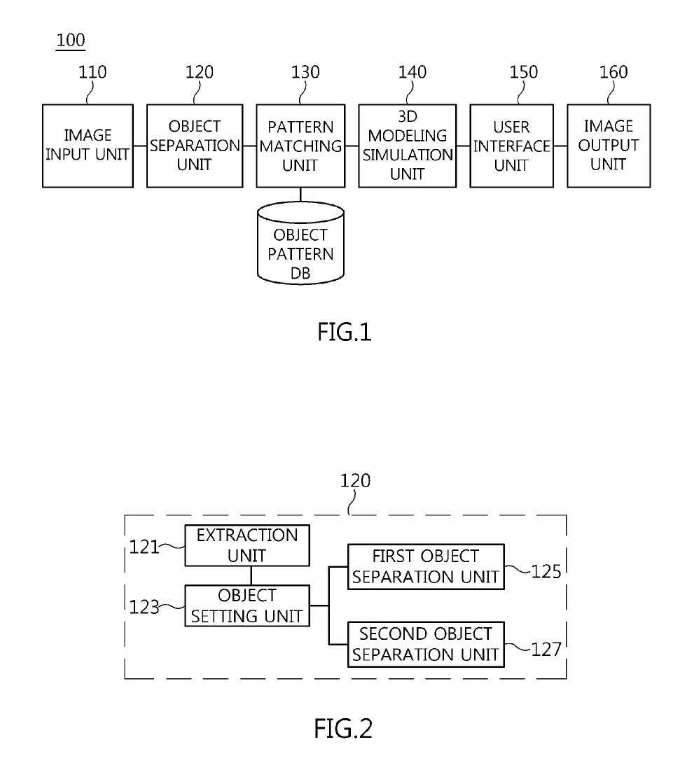

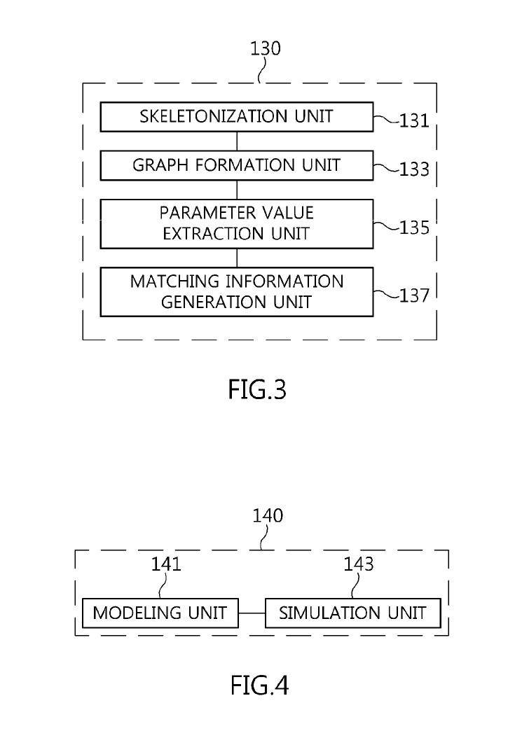

FIG. 1 is a view illustrating a construction of an apparatus for generating 3D tree images according to an embodiment of the present invention. FIG. 2 is a view illustrating a detailed construction of an object separation unit which is adapted to an apparatus for generating 3D tree images according to an embodiment of the present invention. FIG. 3 is a view illustrating a detailed construction of a pattern matching unit which is adapted to an apparatus for generating 3D tree images according to an embodiment of the present invention. FIG. 4 is a view illustrating a detailed construction of a 3D modeling simulation which is adapted to an apparatus for generating 3D tree images according to an embodiment of the present invention.

Referring to FIG. 1, the apparatus for generating 3D tree images according to the present invention comprises an image input unit 110, an object separation unit 120, a pattern matching unit 130, a 3D simulation unit modeling simulation unit 140, a user interface unit 150 and an image output unit 160.

The image input unit 110 is configured to externally receive 2D tree images.

The object separation unit 120 is configured to extract a background and objects from the received 2D tree images and to separate a separation target object from the objects.

As shown in FIG. 2, the object separation unit 120 comprises an extraction unit 121, an object setting unit 123, a first object separation unit 125 and a second object separation unit 127.

The extraction unit 121 is configured to extract a background and objects from 2D tree images. The extraction unit 121 is configured to extract a background and objects using an image matting technique which is implemented based on a user scribble. The image matting technique is directed to separating objects and a background from an actually taken image and is being widely used for the purpose of image processes or image special effects.

The object setting unit 123 stores the kinds of previously set separation target objects. The kinds of the separation target objects may be set as a branch and a leaf.

The first object separation unit 125 is configured to separate branch objects each of which is one of the separation target objects and to store them. The second object separation unit 127 is configured to separate leaf objects each of which is one of the separation target objects and to store them. The branch objects separated by means of the first object separation unit 125 are used during a pattern matching procedure by means of the pattern matching unit 130 and when generating virtual tree models by means of the 3D simulation unit modeling simulation unit 140 both of which are performed afterward.

The pattern matching unit 130 is configured to extract skeleton pattern information from the separation target objects and to generate pattern matching information by matching the skeleton pattern information with tree shape pattern information which is previously stored in an object pattern database.

For the sake of the above mentioned operation, as shown in FIG. 3, the pattern matching unit 130 comprises a skeletonization unit 131, a graph formation unit 133, a parameter value extraction unit 135, and a matching information generation unit 137.

The skeletonization unit 131 is configured to skeletonize a branch object among separation target objects, thus generating skeleton pattern information. In other words, the skeletonization unit 131 performs an object skeletonization from part of an image of a branch object for the purpose of recovering a branch object structure in 3D. In this case, the skeletonization technique is directed to a technique to express a dimension-lowered object shape while maintaining a topology of an object itself, and is used for defining the shape of an object with an axis inside the object and computing a similarity to recognize objects or match objects with one another.

The graph formation unit 133 is directed to expressing skeleton pattern information of a branch object in the form of a graph formed of edges and nodes. The graph formation unit 133 sets the points where the branches are separated and the curvatures of the branches exceed critical values, as nodes and connects the different nodes with edges.

The parameter value extraction unit 135 is configured to extract a parameter value on a branch object from the graph. In other words, the parameter value extraction unit 135 is configured to extract the values of the branch structure type parameters which are previously defined from the graph formation branches. Here, the parameter value may be one among an angle or rotation angle value between the branches and a size ratio value between a parent branch and a child branch.

The matching information generation unit 137 is configured to generate pattern matching information by matching a tree shape and tree shape pattern information which are defined from the parameter values. In other words, the matching information generation unit 137 can generate similar tree shape pattern matching information by way of a comparison analysis between a tree shape defined from an extracted parameter value and an example tree shape of a previously designed tree shape database, in other words, by way of matching them. Meanwhile the matching information generation unit 137 can generate tree leaf shape pattern matching information in combination with an automatic algorithm like an image recognition for matching leaves and an inter semi-automatic method based on a user's input.

The 3D simulation unit modeling simulation unit 140 is configured to generate a 3D virtual tree model with the aid of pattern matching information and to express the generated virtual tree model by way of a self-growth simulation. In this case, the self-growth simulation is directed to a technique of expressing an actual tree and a similar biological growth under the assumption that a tree can be expressed based on a self- and repeatable structure, in other words, based on a self-similarity branching pattern with a certain biological assumption. The virtual tree model according to the present invention is directed to generating a tree body and main branches with the aid of a fractal modeling method and a geometry modeling method having random variables. The tree growth can be expressed by a self-growth simulation under a biological assumption called “competitions between buds and branches in terms of light and space”.

For the sake of the above mentioned operations, as shown in FIG. 4, the 3D simulation unit modeling simulation unit 140 is formed of a modeling unit 141 and a simulation unit 143.

The modeling unit 141 is directed to generating a virtual tree model with the aid of pattern matching information.

The simulation unit 143 is directed to simulating a self-growth of a virtual tree model by way of a self-growth program and expressing it.

The user interface unit 150 is configured to generate a 3D virtual tree image in such a way to receive from a user an editing command on a self-growth simulation of a virtual tree model. All the works for structuring a user-based UI and work environment are characterized in that work contents are managed by the unit of projects, and various view windows and editing interfaces are provided for a user's easier work. For example, the user interface unit 150 is characterized in that a view window is divided into three parts, of which two parts might be used as a user's viewing editing window for an object separation matting with respect to an input image or might be used for a viewing purpose as a result of the matting and a user's editing window, and the remaining one might be used as a window showing a result that a 3D virtual tree model is generated.

The user interface unit 150 helps generate various virtual tree models during the operations by dynamically binding a virtual tree model, so a user can intuitively and easily understand the changes of a virtual tree model by adjusting parameters.

The image output unit 160 is directed to externally outputting in real time the 3D virtual tree images which are edited by way of a self-growth simulation.

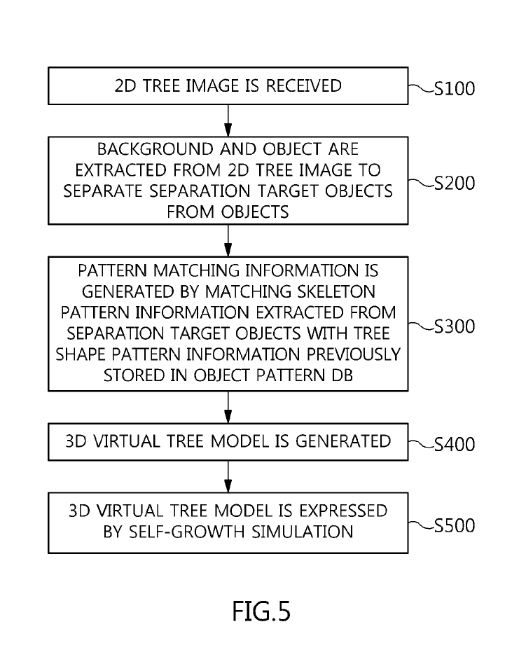

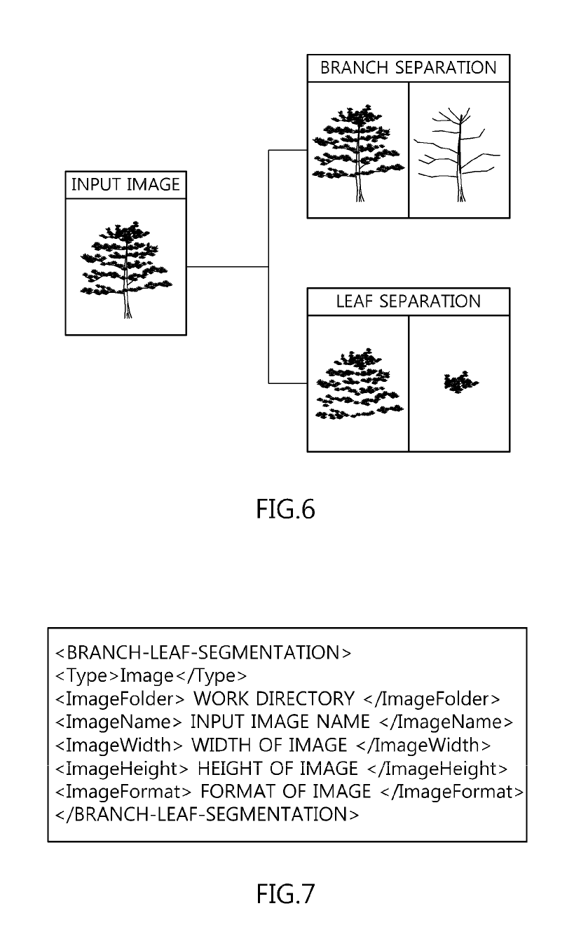

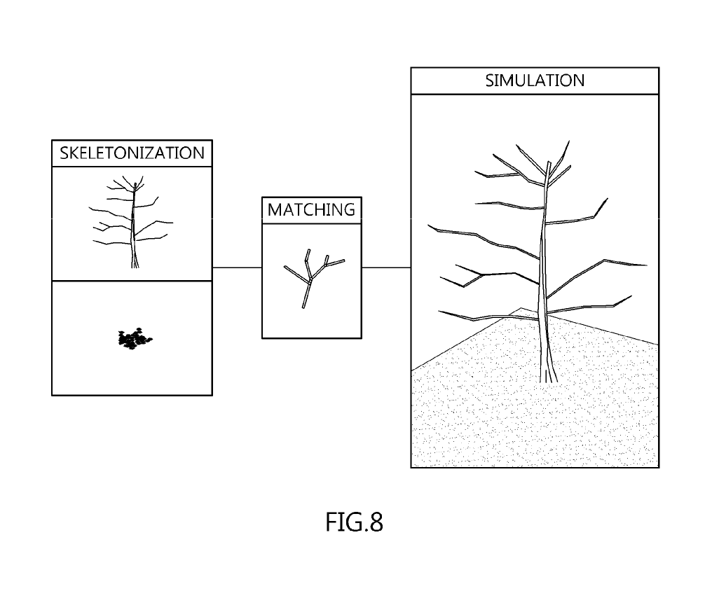

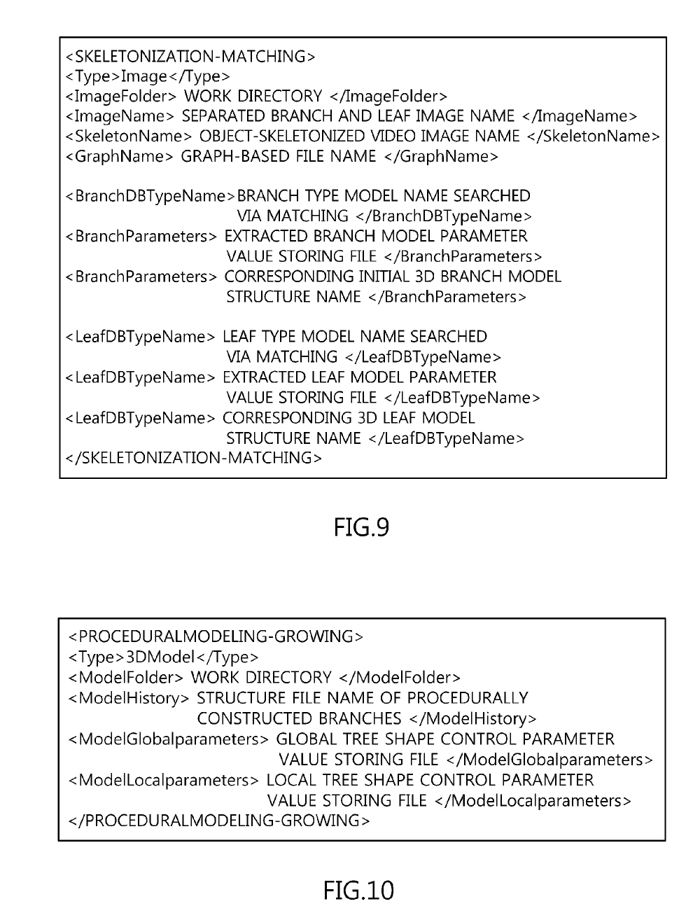

FIG. 5 is a diagram illustrating a flow chart of a method for generating 3D tree images according to an embodiment of the present invention. FIG. 6 is a view illustrating an example of a step S200 of a method for generating 3D tree images according to an embodiment of the present invention. FIG. 7 is a view illustrating work content of a project file which corresponds to a step S200 of a method for generating 3D tree images according to an embodiment of the present invention. FIG. 8 is a view illustrating the examples of steps S300 and S400 of a method for generating 3D tree images according to an embodiment of the present invention. FIG. 9 is a view illustrating work content of a project file which corresponds to a step S300 of a method for generating 3D tree images according to an embodiment of the present invention. FIG. 10 is a view illustrating work content of a project file which corresponds to a step S400 of a method for generating 3D tree images according to an embodiment of the present invention.

As shown in FIG. 5, the method for generating 3D tree images according to the present invention is directed to receiving a 2D tree image from the outside (S 100).

Next, a background and objects are extracted from the 2D tree images, and a separation target object is separated from the objects (S200). As shown in FIGS. 6 and 7, the background and the objects are extracted from the 2D tree images by the object separation unit 120, and a branch object and a leaf object, which are separation target objects, are separated from the objects.

Next, the skeleton pattern information extracted from the separation target object is matched with the tree shape pattern information previously stored in the object pattern database, thus generating pattern matching information (S300). As shown in FIG. 8 or 9, it means that pattern matching information can be generated by matching a tree shape defined from a parameter value extracted from the skeleton pattern information with the tree shape pattern information by the pattern matching unit 130.

Next, a 3D virtual tree model is generated using the pattern matching information (S400), which operation is achieved by means of the 3D simulation unit modeling simulation unit 140.

Next, the generated virtual tree model is expressed by way of a self-growth simulation (S500). As shown in FIG. 8 or 10, the self-growth with respect to the virtual tree model can be simulated by way of the self-growth program with the aid of the 3D simulation unit modeling simulation unit 140.

Next, a 3D virtual tree image is generated in such a way to receive from a user an editing command with respect to the self-growth simulation of the virtual tree model, which operations are achieved by way of the user interface unit 150.

Finally, the 3D virtual tree images edited by way of the self-growth simulation are outputted.

While the present invention has been described with respect to the specific embodiments, it will be apparent to those skilled in the art that various changes and modifications may be made without departing from the spirit and scope of the invention as defined in the following claims.

What is claimed is:

1. An apparatus for generating 3D (3-Dimensional) tree images, comprising:
an object separation unit which is configured to extract a background and objects from an externally received 2D (2-Dimensional) tree image and to separate a separation target object from the objects;
a pattern matching unit which is configured to extract a skeleton pattern information from the separation target object and to generate a pattern matching information by matching the skeleton pattern information with the tree shape pattern information which is previously stored in an object pattern database (DB); and
a 3D simulation unit modeling simulation unit which is configured to generate a 3D virtual tree model based on the pattern matching information and to express the generated virtual tree model by way of a self-growth simulation.

2. The apparatus for generating 3D (3-Dimensional) tree images according to claim 1, wherein the object separation unit comprises:
an extraction unit which is configured to extract the background and the objects from the 2D tree image;
an object setting unit which is configured to store the kinds of the previously set separation target object;
a first object separation unit which is configured to separate and store a branch object which is one of the separation target objects; and
a second object separation unit which is configured to separate and store a leaf object which is one of the separation target objects.

3. The apparatus for generating 3D (3-Dimensional) tree images according to claim 2, wherein the extraction unit is configured to extract the background and the objects using an image matting technique.

4. The apparatus for generating 3D (3-Dimensional) tree images according to claim 1, wherein the pattern matching unit comprises:
a skeletonization unit which is configured to generate skeleton pattern information in such a way to skeletonize a branch object among the separation target obj ects;
a graph formation unit which is configured to express the skeleton pattern information of the branch object in a form of a graph formed of edges and nodes;
a parameter value extraction unit which is configured to extract a parameter value with respect to the branch object from the graph; and
a matching information generation unit which is configured to generate pattern matching information in such a way to match a tree shape defined from the parameter value with the tree shape pattern information.

5. The apparatus for generating 3D (3-Dimensional) tree images according to claim 4, wherein the parameter value is one among an angle or rotation angle value between the branches and a size ratio value between a parent branch and a child branch.

6. The apparatus for generating 3D (3-Dimensional) tree images according to claim 1, wherein the 3D simulation unit modeling simulation unit comprises:
a modeling unit which is configured to generate the virtual tree model using the pattern matching information; and
a simulation unit which is configured to simulate the self-growth of the virtual tree model by way of a self-growth program.

7. The apparatus for generating 3D (3-Dimensional) tree images according to claim 1, further comprising:
a user interface which is configured to generate a 3D virtual tree image in such a way to receive from a user an editing command with respect to a self-growth simulation of the virtual tree model.

8. A method for generating 3D (3-Dimensional) tree images, comprising:
externally receiving a 2D (2-Dimensional) tree image;
separating a separation target object from objects after extracting a background and the objects from a 2D (2-Dimensional) tree image;
generating pattern matching information in such a way to match skeleton pattern information extracted from the separation target object with the tree shape pattern information which is previously stored in an object pattern database;
generating a 3D virtual tree model using the pattern matching information; and
expressing the generated virtual tree model based on a self-growth simulation.

9. The method for generating 3D (3-Dimensional) tree images according to claim 8, wherein the step of separating a separation target object from the objects is characterized in that the background and the objects are extracted from the 2D tree images using an image matting technique and a branch object and a leaf object, which are separation target objects, are separated from the objects.

10. The method for generating 3D (3-Dimensional) tree images according to claim 8, wherein the step of generating a pattern matching information is characterized in that the skeleton pattern information is generated in such a way to skeletonize a branch object among the separation target objects.

11. The method for generating 3D (3-Dimensional) tree images according to claim 8, wherein the step of generating pattern matching information, is characterized in that the pattern matching information is generated in such a way to match a tree shape defined from a parameter value extracted from the skeleton pattern information with the tree shape pattern information.

12. The method for generating 3D (3-Dimensional) tree images according to claim 8, wherein the step of expressing the generated virtual tree model based on a self-growth simulation is characterized in that a self-growth with respect to the virtual tree model is simulated by way of a self-growth program.

13. The method for generating 3D (3-Dimensional) tree images according to claim 8, wherein the step of expressing the generated virtual tree model based on a self-growth simulation is characterized in that a 3D virtual tree image is generated in such a way to receive from a user an editing command with respect to a self-growth simulation of the virtual tree model.
